(19) United States
(12) Patent Application Publication
(10) Pub. No.: US 2009/0177302 A1
(43) Pub. Date: Jul. 9, 2009

(54) SENSOR INFORMATION OBTAINING APPARATUS, SENSOR DEVICE, INFORMATION PRESENTING APPARATUS, MOBILE INFORMATION APPARATUS, SENSOR CONTROL METHOD, SENSOR PROCESSING METHOD, AND INFORMATION PRESENTING METHOD

(75) Inventors: Tetsujiro KONDO, Tokyo (JP); Akihiko Arimitsu, Kanagawa (JP); Junichi Shima, Tokyo (JP); Takuro Ema, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/348,978

(22) Filed: Jan. 6, 2009

(30) Foreign Application Priority Data
Jan. 7, 2008 (JP) 2008-000813
May 1, 2008 (JP) 2008-120029

(51) Int. Cl. G05D 1/12; G06F 17/00

(52) U.S. Cl. 700/94; 700/302

(57) ABSTRACT

Disclosed is a sensor information obtaining apparatus that includes a plurality of sensors each configured to obtain positional information thereof, and a sensor position control unit configured to control positions of the sensors to be moved based on distribution of data obtained by the sensors and distribution of positions of the sensors.

### CROSS REFERENCES TO RELATED APPLICATIONS

The present invention contains subject matter related to Japanese Patent Application P2008-000813 filed in the Japanese Patent Office on Jan. 7, 2008 and Japanese Patent Application P2008-120029 filed in the Japanese Patent Office on May 1, 2008, the entire contents of which being incorporated herein by reference.

### BACKGROUND OF THE INVENTION

1. Field of the Invention

The invention relates to a sensor information obtaining apparatus, sensor device, information presenting apparatus, mobile information presenting device, and sensor control method, sensor processing method, and information presenting method, and specifically, to technology applied to a system including a plurality of sensors.

2. Description of the Related Art

Japanese Unexamined Patent Application Publication No. 2004-266511 discloses technology in which positions of a plurality of sensors are controlled.

The disclosed technology shows an example of an imaging apparatus in which cameras each having an imaging unit are used as sensors. The cameras are configured to support a plurality of imaging units that can successively change relative positions thereof using support mechanisms. Since positional information on each of the imaging units supported by each of the supporting mechanisms has been recorded in advance, the imaging units can be located in the same position again based on the recorded information.

Accordingly, a condition similar to a condition in which images have previously been captured can be reproduced. Japanese Unexamined Patent Application Publication No. 2004-266511 shows an example of an imaging apparatus utilizing imaging units as sensors; however, other types of devices can also be used therefor as the sensors. For example, a condition in which audio data is currently obtained can be set to a microphone that is used as a sensor in the same manner as a condition in which audio data has previously been obtained.

### SUMMARY OF THE INVENTION

Recently, more advanced technology to control positions of sensors has been desired. Specifically, only to reproduce a previous condition in which images have been recorded may not be sufficient in reproducing a condition in which sensors have obtained data. For example, in a case where cameras and microphones are used as sensors, only to reproduce the recorded positions of the cameras and microphones may not be sufficient to follow the current conditions of a subject or sound source.

According to embodiments of the invention, data can be appropriately obtained utilizing a plurality of sensor devices. According to the embodiments of the invention, information obtained by the plurality of sensor devices can be suitably presented.

A sensor information obtaining apparatus according to the embodiment of the invention is applied to a system having a plurality of sensors each configured to obtain positional information thereof. The positions of the plurality of sensors are controlled by a sensor position control unit. The sensor position control unit controls positions of the sensors to be moved based on distribution of data obtained by the sensors and distribution of positional data of the sensors.

The sensor devices according to an embodiment of the invention are utilized for a sensor information obtaining system. Each of the sensor devices includes a sensor function unit to obtain predetermined data and a positional information obtaining unit to obtain positional information on the sensors.

A sensor control method according to an embodiment of the invention includes obtaining positional information on a plurality of movable sensors, and carrying out processing of moving positions of the sensors based on distribution of data obtained by the sensors and distribution of positions of the sensors.

A sensor processing method according to an embodiment of the invention includes obtaining positional information on a sensor while obtaining predetermined data utilizing a sensor function unit, and outputting the obtained positional information and the predetermined data.

With these embodiments of the invention, the sensor devices are moved based on distribution of data obtained by the sensor devices and distribution of positions of the sensor devices, so that the sensor devices can each be controlled to appropriately obtain data.

An information presenting apparatus according to an embodiment of the invention includes a plurality of information presenting units to present information obtained by a plurality of various sensors, and respective driving mechanisms to change setting of positions of the information presenting units. The information presenting apparatus controls the driving mechanisms to individually set positions of the information presenting units according to positional information obtained when the sensors have obtained information.

A mobile information presenting device according to an embodiment of the invention includes information presenting units to output predetermined data, and driving mechanisms to move the information presenting units based on information added to data to be presented.

An information presenting method according to an embodiment of the invention includes individually presenting information obtained by a plurality of sensors, and individually setting presenting positions for presenting the information corresponding to positional information obtained when the sensors have obtained the information.

The information presenting method also includes presenting information by outputting predetermined data while moving a position of presenting data based on the positional information added to the information to be presented.

With these embodiments of the invention, positions to individually present data can be controlled such that data are presented in the same manner as those have previously been presented, based on distribution of data obtained by the sensor devices and positions of the sensor devices such that the sensor devices can each be controlled to appropriately obtain data.

According to an embodiment of the invention, positions of the sensor devices can be controlled such that the sensor devices can properly obtain data. For example, if microphones are used as the sensor devices, the microphones can be moved based on distribution of audio sound data detected by the microphones so as to appropriately capture sound from sound source.

According to an embodiment of the invention, positions at which the obtained data is presented can be changed using data obtained by a plurality of sensor devices and positional information obtained when the sensor devices have obtained the data. Thus, information can be presented by reproducing a condition in which the sensor devices have obtained the data. For example, sound or images can appropriately output by reproducing the condition in which the sensor devices have obtained the sound or images.

### BRIEF DESCRIPTION OF THE DRAWINGS

FIG. 1 is a configuration diagram illustrating an example of a system configuration according to an embodiment of the invention.

FIG. 2 is a block diagram illustrating an example of a sensor device configuration according to an embodiment of the invention.

FIG. 3 is a top view illustrating an example of the sensor device according to an embodiment of the invention.

FIG. 4 is a side view illustrating an example of the sensor device according to an embodiment of the invention.

FIG. 5 is a front view illustrating an example of the sensor device according to an embodiment of the invention.

FIG. 6 is an explanatory diagram illustrating an example of a drive configuration of the sensor device according to an embodiment of the invention.

FIGS. 7A, 7B are explanatory diagrams illustrating an example of a sensor arrangement (linearly arranged) according to an embodiment of the invention.

FIGS. 8A, 8B are explanatory diagrams illustrating an example of a sensor arrangement (circularly arranged) according to an embodiment of the invention.

FIG. 9 is a flowchart illustrating an example of sensor arrangement processing according to an embodiment of the invention.

FIG. 10 is a flowchart illustrating an example of sensor re-arrangement processing according to an embodiment of the invention.

FIGS. 11A, 11B are explanatory diagrams illustrating modification of a sensor arrangement based on an amount of characteristic according to an embodiment of the invention.

FIGS. 12A, 12B, 12C are explanatory diagrams illustrating modification of the sensor arrangement (linearly arranged) according to an embodiment of the invention.

FIGS. 13A, 13B are explanatory diagrams illustrating modification of the sensor arrangement (circularly arranged) according to an embodiment of the invention.

FIG. 14 is an explanatory diagram illustrating an example of distance ratio of sensor intervals according to an embodiment of the invention.

FIG. 15 is a block diagram illustrating an example of a sensor device according to an embodiment of the invention.

FIG. 16 is a configuration diagram illustrating an example of the system configuration according to another embodiment of the invention.

FIG. 17 is a configuration diagram illustrating an example of the system configuration according to still another embodiment of the invention.

FIGS. 18A, 18B are respectively a front view and a side view illustrating an example of an information presenting apparatus according to an embodiment of the invention.

FIGS. 19A, 19B are respectively a front view and a side view illustrating modification of the information presenting apparatus according to an embodiment of the invention.

FIG. 20 is a configuration diagram illustrating still another modification of the information presenting apparatus according to an embodiment of the invention.

FIGS. 21A, 21B are configuration diagrams respectively illustrating an example of a front view and a side view of the position-variable mechanism of the information presenting apparatus according to an embodiment of the invention.

FIG. 22 is a top view illustrating an example of drive configuration of a mobile presenting device according to an embodiment of the invention.

FIG. 23 is a side view illustrating an example of the drive configuration of the mobile presenting device according to an embodiment of the invention.

FIG. 24 is a block diagram illustrating a system configuration example of the information presenting apparatus according to an embodiment of the invention.

FIG. 25 is a block diagram illustrating a configuration example of the mobile presenting device according to an embodiment of the invention.

FIG. 26 is a flowchart illustrating an example of sensor re-arrangement processing according to an embodiment of the invention.

FIG. 27 is a configuration diagram illustrating an example of two information presenting apparatuses interlocked each other according to an embodiment of the invention.

FIGS. 28A, 28B are configuration diagrams illustrating an example of the information presenting apparatus (to which the mobile presenting devices that can individually drive in a vertical direction are provided) according to an embodiment of the invention.

FIGS. 29A, 29B are configuration diagrams illustrating an example of the information presenting apparatus (to which a plurality of mobile carriages are provided) according to an embodiment of the invention.

FIGS. 30A, 30B are configuration diagrams illustrating an example of the information presenting apparatus (to which a display is provided) according to an embodiment of the invention.

FIGS. 31A, 31B are configuration diagrams illustrating an example of the information presenting apparatus (to which the mobile presenting devices that can individually drive in a vertical direction are provided) according to an embodiment of the invention.

FIGS. 32A, 32B, 32C are configuration diagrams illustrating an example of the information presenting apparatus a frame of which is curved according to an embodiment of the invention.

FIGS. 33A, 33B, 33C are configuration diagrams illustrating an example of the information presenting apparatus to which mobile presenting devices are arranged in a curved fashion according to an embodiment of the invention.

FIG. 34 is an explanatory diagram illustrating an example in which a plurality of the apparatuses in FIGS. 33A, 33B, 33C are arranged in an interlocked manner.

### DESCRIPTION OF THE PREFERRED EMBODIMENTS

An embodiment of the invention is described below with reference to accompanying drawings.

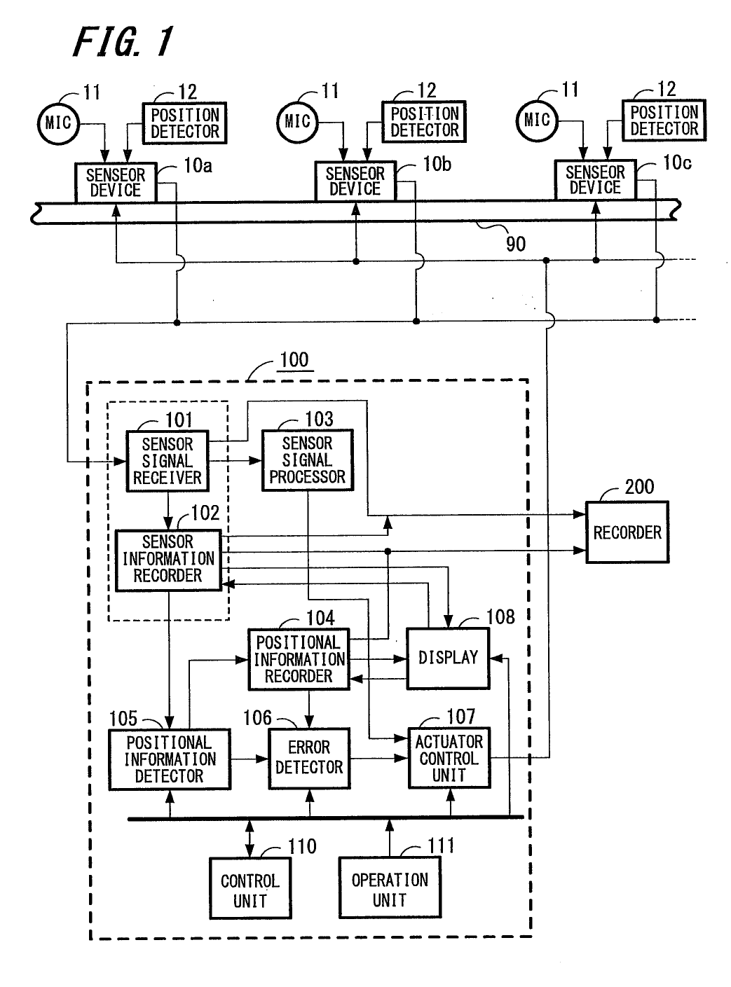

The embodiment of the invention pertains to a system that obtains data such as audio sound, and presents such data. First a configuration and processing of a portion of the system that obtains data are described with reference to FIGS. 1 to 7.

FIG. 1 is a diagram illustrating an example of an overall system configuration according to an embodiment of the invention. As illustrated in FIG. 1, sensor devices 10a, 10b, 10c, . . . are movably arranged along a rail 90. In an example of FIG. 1, three sensors 10a, 10b, 10c are arranged in the portion of the system.

More sensor devices are actually provided to the portion of the system than the sensor devices shown in the example. Detailed description of the configuration such as mechanism that allows the sensor devices 10a, 10b, 10c to move will be provided later. The sensor devices 10a, 10b, 10c each include a microphone 11 that collects sound as a data collecting sensor. The sensor devices 10a, 10b, 10c each include a position detector 12 that detects a position of own sensor device.

The sensor devices 10a, 10b, 10c each transfer data collected by themselves (i.e., audio data collected by the microphone 11) to a sensor information obtaining apparatus 100, and the data processed by the sensor information obtaining apparatus 100 is recorded by a recorder 200. The sensor devices 10a, 10b, 10c also transfer positional information detected by the position detectors 12 thereof to the sensor information obtaining apparatus 100. Transmission of data between the sensor devices 10a, 10b, 10c and the sensor information obtaining apparatus 100 can be conducted either via wired transmission utilizing a wired transmission line or via wireless transmission using a wireless communication device.

Next, a configuration of the sensor information obtaining apparatus 100 to which data is supplied from the sensor devices is described.

The sensor information obtaining apparatus 100 includes a sensor signal receiver 101, which receives and records sensor information on a sensor information recorder 102. The sensor signal receiver 101 also supplies and records the received sensor signal on a recorder 200 that is provided independent of the sensor information obtaining apparatus 100. Each sensor device in this embodiment includes a microphone as a sensor. Audio data collected by the microphone is recorded by the recorder 200. The audio data received by each of the sensor devices 10a, 10b, 10c . . . is recorded as independent audio data for each channel. On recording such data, the audio data for each channel may be provided with positional information on each sensor. The positional information on each sensor is supplied from the sensor information recorder 102 to the recorder 200.

The sensor information received by the sensor signal receiver 101 is transferred to a sensor signal processor 103, which then analyzes the data of the sensor information (audio data in this embodiment) received by the sensor devices. Having analyzed the data, the sensor signal processor 103 transmits instructions to an actuator control unit 107 based the results of analysis. Detailed examples of analysis and processing will be described later.

The positional information on the sensors is supplied from the sensor information recorder 102 to a display 108 so as to display positions of the sensor devices thereon.

The positional information on sensors received by the sensor information recorder 102 is transferred to a positional information recorder 104 via a positional information detector 105. Positional information recorded on the positional information recorder 104 and those detected by the positional information detector 105 are transferred to an error detector 106, in which an error between a controlled position of the sensor and an actual position of the sensor is detected.

The actuator control unit 107 is a device that controls driving of each of the sensor devices 10a, 10b, 10c . . . to move the position thereof. Driving instructions to move the position of each of the sensor devices are supplied from the sensor signal processor 103 to the actuator controller 107. The actuator control unit 107 drives the sensor devices 10a, 10b, 10c, . . . in compliance with the appropriate instructions, and carries out processing of compensating an error of the driven position based on an error signal supplied from the error detector 106.

Processing of components in the sensor information obtaining apparatus 100 is controlled by a control unit 110. The sensor information obtaining apparatus 100 further includes an operation unit 111, and the control unit 110 controls the components of the sensor information obtaining apparatus 100 based on an operational status of the operation unit 111.

Next, a configuration of each sensor 10a, 10b, 10c . . . is described.

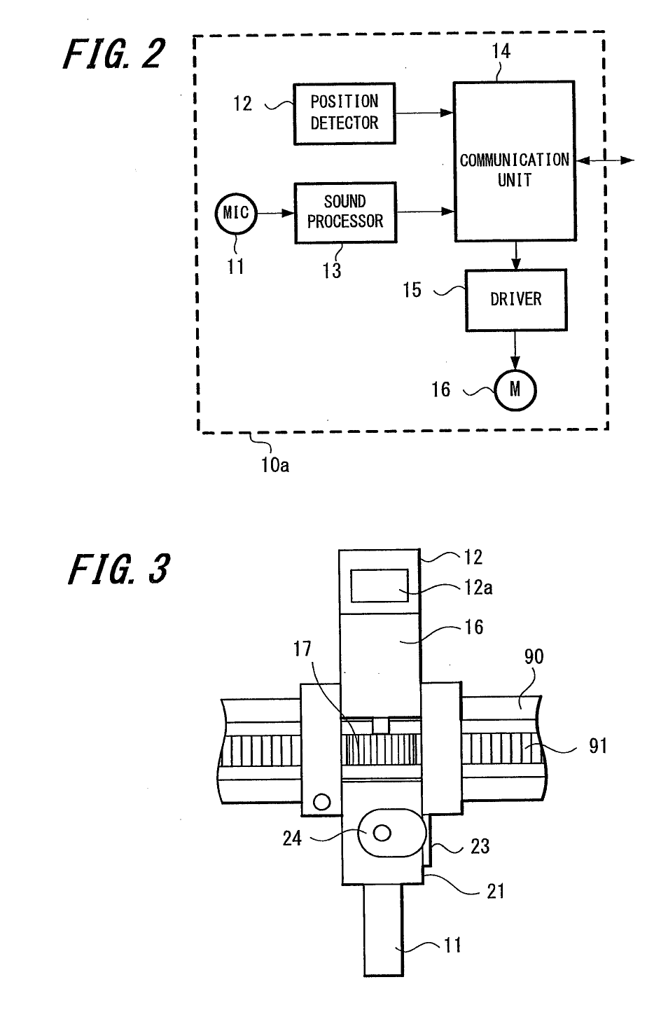

FIG. 2 illustrates a configuration of the sensor 10a, however, other sensors 10b, 10c, . . . also have the same configurations. The sensor device 10a includes a microphone 11 to collect ambient audio sound. A sound processor 13 receives an output signal from the microphone 11, converts the output signal into audio data, and transmits and supplies the data to a communication unit 14. The sensor 10a further includes the position detector 12. As an example of the position detector 12 includes a position detector that receives a positioning signal from GPS (Global Positioning System) to calculate the absolute position of the sensor 10a, thereby locating the current position thereof.

The positional information detected by the position detector 12 is transferred to the communication unit 14.

The communication unit 14 carries out output processing to transmit the sensor information including audio data and positional information to the sensor information obtaining apparatus 100.

The sensor device 10a further includes a motor 16 driven by a driver 15. The position of the sensor device is moved along the rail 90 shown in FIG. 1. The driver 15 is controlled based on the driving instructions received by the communication unit 14. Actuator controlling data indicates instructions supplied from the actuator control unit 107 of the sensor information obtaining apparatus 100 shown in FIG. 100.

FIGS. 3 to 6 illustrate mechanical configuration examples of the sensor devices 10a, 10b, 10c . . . .

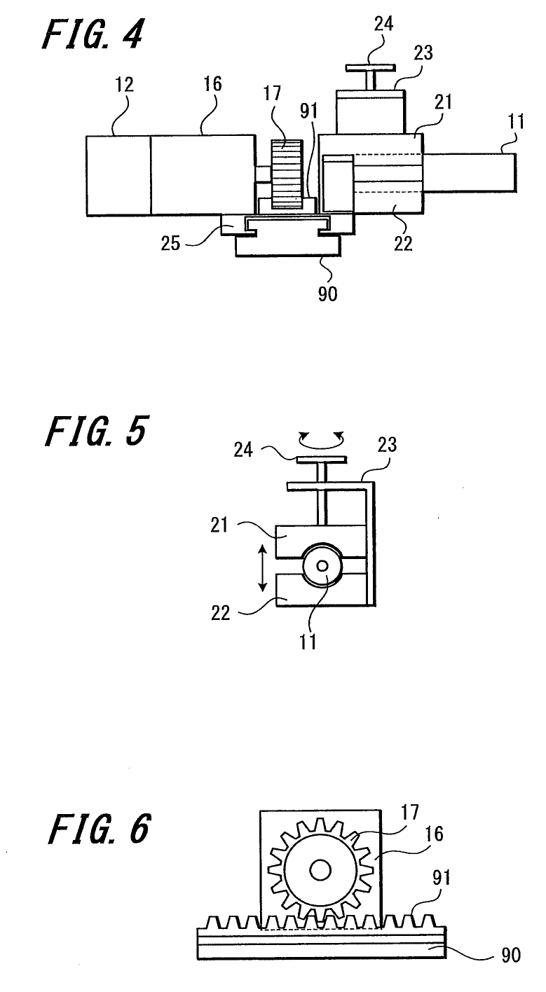

Each of the sensor devices of the embodiment includes a slider 25 fitted into the rail 90 to move the sensor device therealong, as illustrated in the top view of FIG. 3 and the side view of FIG. 4.

As shown in FIG. 4, the position detector 12 and motor 16 are arranged on the slider 25. The position detector 12 further includes a positioning signal receiver 12a formed of antenna arranged on the surface of the position detector 12 as illustrated in FIG. 3. The motor 16 includes a gear 17, as illustrated in FIGS. 4 and 6, which is engaged in a rack 91. The rack 91 is provided along the rail 90.

A microphone 11 of the sensor is provided on the slider 25 to be sandwiched between an upper bracket 21 and a lower bracket 22. As illustrated in FIG. 5, the microphone 11 is sandwiched between the upper bracket 21 and lower bracket 22 by tightening a screw 24 on a screw support member 23 that is mounted on the sensor devices side.

The sound processor 13, communication unit 14, and driver 15 shown in FIG. 2 are incorporated in an enclosure of the position detector 12.

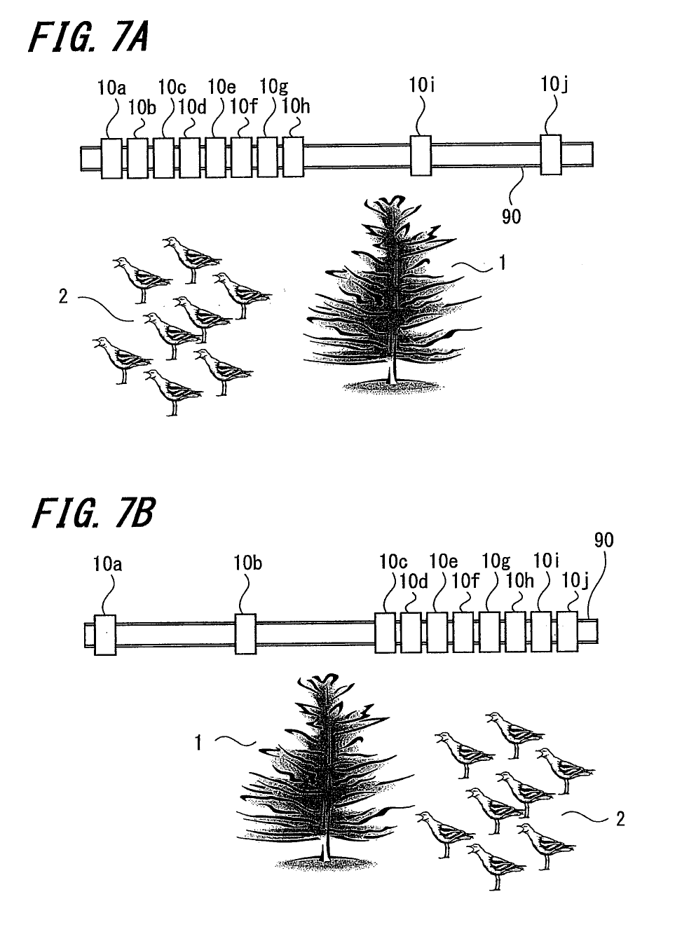

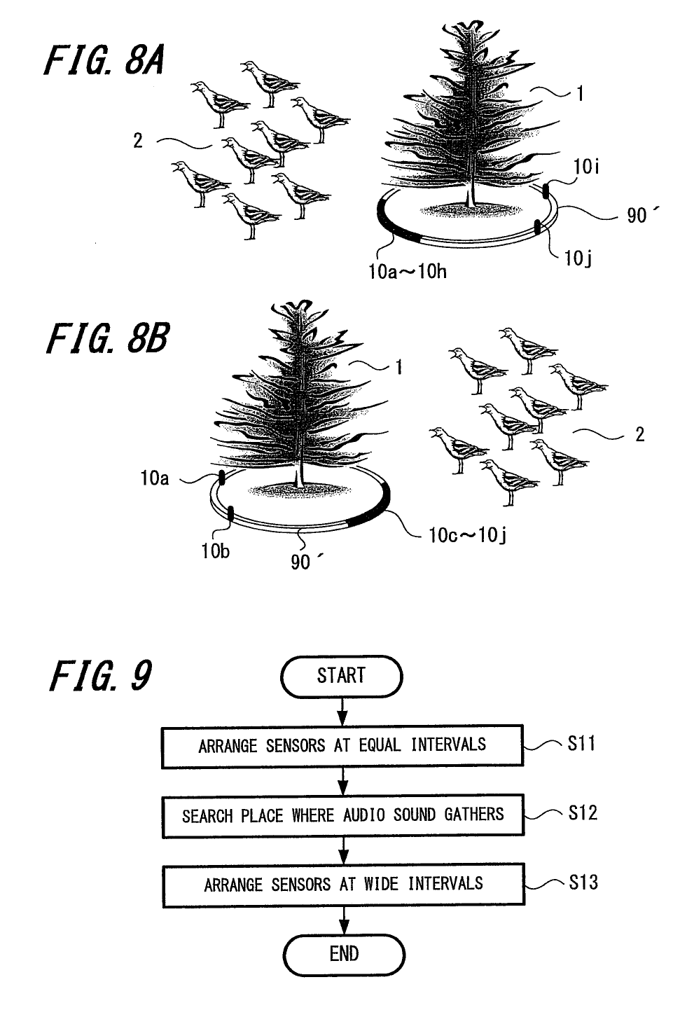

Next, examples of arranging the sensor devices 10a, 10b, 10c are described with reference to FIGS. 7A, 7B, and FIGS. 8A, 8B. FIGS. 7A, 7B illustrate an example of arranging ten sensor devices 10a to 10j on a straight rail 90. In contrast, FIGS. 8A, 8B each illustrate an example of arranging ten sensor devices 10a to 10j on a circular (cyclic) rail 90′.

In FIGS. 7A, 7B, and FIGS. 8A, 8B, there is a flock of birds 2 near a tree 1, and the sensor devices with the microphones 11 are arranged to pick up sound of the flock of birds 2 singing.

As shown in FIG. 7A, in a case where the flock of birds is on the left side of the tree 1, the sensor devices 10a to 10h of ten sensor devices 10a to 10j are arranged along the rail 90 with narrow intervals while only the two sensor devices 10i and 10j are arranged along the rail 90 with wide intervals on the left side of the tree 1.

As shown in FIG. 7B, in a case where the flock of birds is on the right side of the tree 1, the sensor devices 10c to 10j of the ten sensor devices 10a to 10j are arranged along the rail 90 with narrow intervals while only the two sensor devices 10a and 10b are arranged along the rail 90 with wide intervals on the right side of the tree 1.

Next, an example of arranging the sensor devices on the cyclic rail 90′ is described as shown in FIGS. 8A, 8B. As shown in FIG. 8A, in a case where the flock of birds is on the left side of the tree 1, of ten sensor devices 10a to 10j, the sensor devices 10a to 10h are arranged along the rail 90′ with narrow intervals while two sensor devices 10i and 10j are arranged along the rail 90′ with wide intervals on the left side of the tree 1.

As shown in FIG. 7B, in a case where the flock of birds is on the right side of the tree 1, of ten sensor devices 10a to 10j, the sensor devices 10c to 10j are arranged along the rail 90 with narrow intervals while only two sensor devices 10a and 10b are arranged along the rail 90 with wide intervals on the right side of the tree 1.

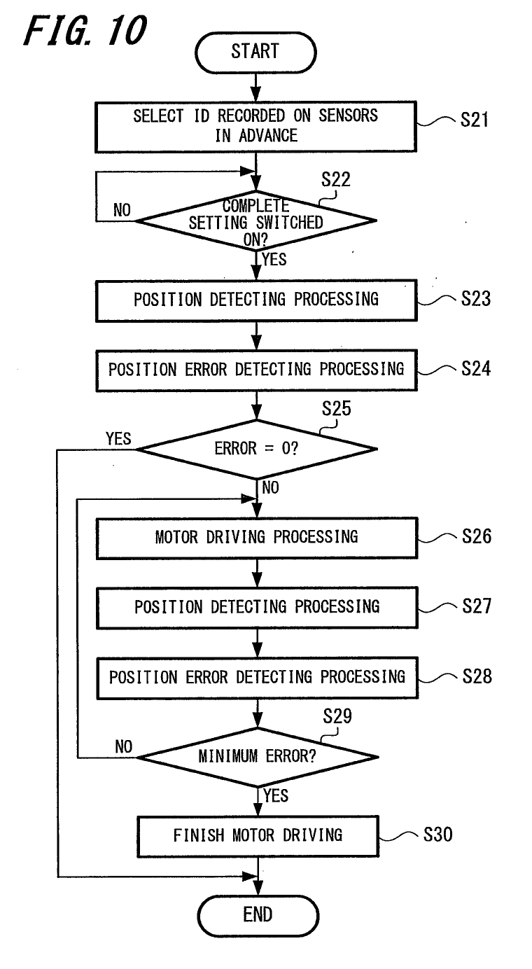

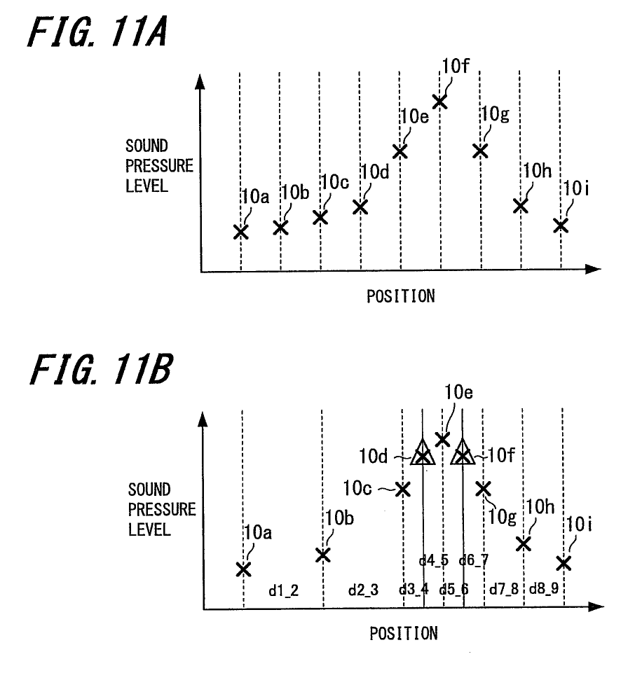

Next, control processing in FIGS. 7A, 7B, and FIGS. 8A, 8B are described with reference to flowcharts in FIGS. 9 and 10. The flowchart in FIG. 9 illustrates a processing example of controlling positions of the sensor devices. For example, the positions of the sensor devices are controlled by the control unit 110 of the sensor information obtaining apparatus 100. First, the control unit 110 arranges the sensor devices 10a, 10b, 10c, . . . at approximately equal intervals as default positions thereof (step S11). The sensor signal processor 103 of the sensor information obtaining apparatus 100 then analyzes the audio data of the sensor information transferred from the sensor devices 10a, 10b, 10c, . . . arranged at approximately equal intervals so as to search a place where the audio sound gathers (step S12). The search processing is carried out based on distribution of sound level computed from the audio data collected from the microphones of the sensor devices. How the search processing is carried out with the sound level will be described later.

The sensor devices 10a, 10b, 10c, . . . are arranged at narrow intervals where the sound gathers whereas the sensor devices 10a, 10b, 10c, . . . are sparsely arranged at wide intervals where the sound ungathers.

The processing ends a step S13 as shown in the flowchart of FIG. 9. However, after having ended the processing at step S13, the arranged positions of the sensor devices may sequentially be changed in real-time by re-conducting determination processing of step S12.

The flowchart in FIG. 10 illustrates an processing example where the positions of the sensor devices 10a, 10b, 10c, . . . are controlled by causing the sensor devices to move on the rail 90 based on instructions from the sensor information obtaining apparatus 100.

First, an identification number (ID) of a sensor device to be moved is selected (step S21). ID is individually provided for each of the sensor devices in advance. The processing stands by until whether the sensor device in question has been switched on is determined by a response therefrom (step S22). When the sensor device in question that has been switched on is determined, the absolute current position of the sensor device in question is detected by the position detector 12 incorporated in the sensor device (step S23). Error detection processing is then carried out by determining whether there is a difference between a target position specified by the sensor information obtaining apparatus 100 and the current position of the sensor in question (step S24).

In the error detection processing, whether an error has been zero is determined (step S25). If the error is determined as zero, the moving control processing on the sensor device with the selected ID will end.

If the error is not determined as zero, motor driving instructions are transferred to the sensor device so that the sensor device is moved with a distance corresponding to the error (step S26). The position of the moved sensor device is then measured by the position detector 12 of the moved sensor (step S27), and the error detection processing is conducted by determining whether there is a difference between the target position specified by the sensor information obtaining apparatus 100 and the current position of the sensor (step S28). Subsequently, whether the error obtained has been the smallest is determined (step S29), and if the error is not the smallest, the processing returns to step S26 to adjust the position of the sensor device again.

If the error obtained is the smallest at step S29, driving control of the motor will end (step S30), and moving control processing of the sensor device with the selected ID will subsequently end.

Next, examples of modification processing for density of the sensor devices (intervals between the sensor devices) will be described with reference to FIGS. 11A, 11B. FIGS. 11A, 11B illustrate arrangement examples of nine sensors 10a to 10i. In graphs in FIGS. 11A, 11B, vertical axes of each represent a sound pressure level collected by the microphones 11 attached to the sensors, whereas horizontal axes represent positions (distance) of the sensor devices on the rail.

FIG. 11A shows the default positions of the sensor devices. As shown in FIG. 11A, the sensor devices 10a to 10i are arranged at approximately equal intervals in the default positions of the sensor devices.

The position of the sensor device with the highest sound pressure level is specified when change in the sound pressure level is detected, the specified position is estimated as a position where sound source derives. In FIG. 11A, the sound collected by the sensor device 10f shows the highest level of the sound pressure.

The sensor devices located near the current position of the sensor device 10f are gathered to the sensor device 10f at relatively narrow intervals, whereas the sensor devices located distant from the current position of the sensor device 10f are arranged at wide intervals.

FIG. 11B shows an example in which positions of the sensors are changed. In FIG. 11B, the original position of the sensor device 10f is determined as where the highest level of the sound pressure is. The sensor devices 10c to 10g are gathered and arranged closed to the position of the highest level of the sound pressure. The intervals between the sensor devices will be gradually wider as the sensor devices are more distant from the position of the highest level of the sound pressure. Distances d1_2, d2_3, . . . , and d8_9 each represent a distance from adjacent sensor devices.

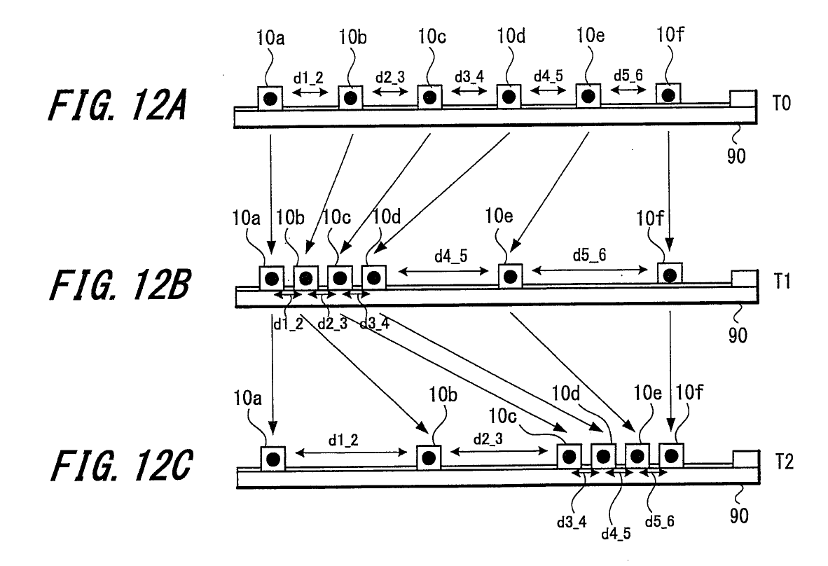

FIGS. 12A, 12B, 12C illustrate positional change of the sensor devices when the sensor devices are moved from the positions thereof illustrated in FIG. 7A, 7B along the straight rail 90 to collect the audio sound. In this example, six sensor devices 10a to 10f are arranged along the rail 90.

As illustrated in FIG. 12A, six sensor devices 10a to 10f are arranged at approximately equal intervals along the rail 90 in the default positions.

In the case where the flock of birds 2 is on the left side of the tree 1 as illustrated in FIG. 7A, the sensor devices 10a to 10d are densely gathered around the sound source position on the left side of the tree 1 where the flock of birds 2 is as illustrated in FIG. 12B. The sensor devices located distant from the position where the flock of birds 2 is are arranged at wide intervals.

In the case where the flock of birds 2 is on the right side of the tree 1 as illustrated in FIG. 7B, the sensor devices 10c to 10f are densely gathered around the sound source position on the right side of the tree 1 where the flock of birds 2 is as illustrated in FIG. 12C. The sensor devices located distant from the position where the flock of birds 2 is are arranged at wide intervals.

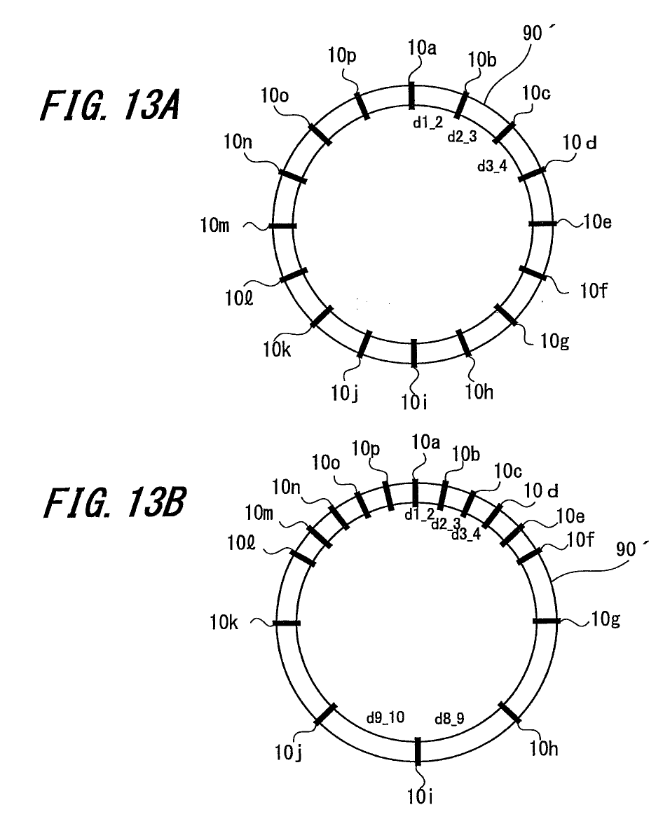

FIGS. 13A, 13B illustrate positional change of the sensor devices when the sensor devices are moved from the positions thereof illustrated in FIG. 8A, 8B along the cyclic rail 90′ to collect the audio sound, which is an example of arranging 16 sensor devices 10a to 10p.

As illustrated in FIG. 13A, 16 sensor devices 10a to 10p are arranged at approximately equal intervals along the rail 90′ in the default positions.

In the case where the flock of birds 2 is on one side of the tree 1 as illustrated in FIGS. 8A, 8B, the sensor devices 10a to 10f, and 10l to 10p are densely gathered around the sound source position on the side of the tree 1 where the flock of birds 2 is as illustrated in FIG. 13B. The sensor devices located distant from the position where the flock of birds 2 is are arranged at wide intervals.

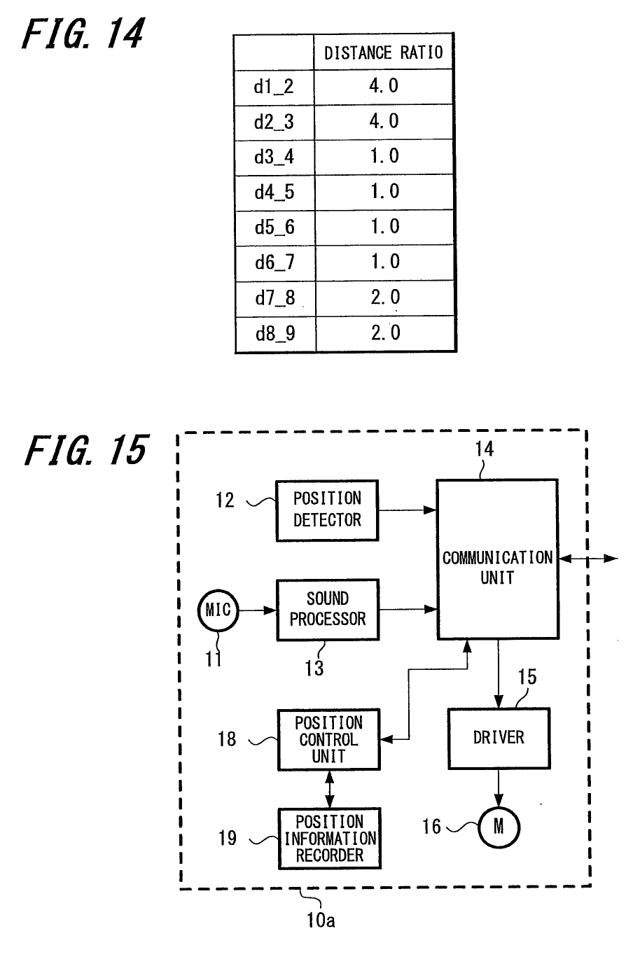

FIG. 14 is an example illustrating the relationship in the distance (distance ratio) between the sensor devices when high level of sound pressure is detected. In this example, when a first distance between the adjacent sensor devices closely arranged is determined as 1, a second distance (longest distance) therebetween is determined as four times the first distance, and a third distance therebetween is determined as twice the first distance. The distance between the adjacent sensor devices, such as once, twice, four times the first distance, are determined according to levels of detected sound pressure. However, the distance ratio in FIG. 14 is only an example and the ratio can be set more precisely.

Accordingly, since positions of the sensor devices can be adjusted according to the positions where the high level or low level of sound pressure is detected, sound derived from sound source can adequately and effectively be recorded. For example, sound with preferred sound effect can be recorded utilizing the audio data collected and recorded by the recorder 200 (FIG. 1).

With the system configuration example shown in FIG. 1, the sensor information obtaining apparatus 100 independent of the sensor devices is provided to control positions of the sensor devices; however, a positional control function may be incorporated in each of the sensor devices.

For example, as shown in FIG. 15, a position controller 18 and position information recorder 19 can be incorporated in a sensor device. The position controller 18 communicates with other sensor devices via the communication unit 14 to specify the position of each of the sensor devices. The position controller 18 figures out an appropriate position of each of the sensor devices based on the level of the sound pressure detected by each of the sensor devices. Other components of the sensor device in FIG. 15 are configured the same as those of the sensor device illustrated in FIG. 2.

FIG. 15 illustrates a configuration of one of the sensor devices in a centralized control configuration that is capable of controlling positions of other sensor devices arranged on the rail. Alternatively, the plurality of sensor devices may each include such configuration illustrated in FIG. 15 such that the sensor devices can each independently control positions thereof in a decentralized manner.

The sensor device illustrated in FIGS. 1 and 2 includes the microphone 11 collecting sound, from which the position of the sound source is figured out; however, the sensor device may include devices other than the microphone 11.

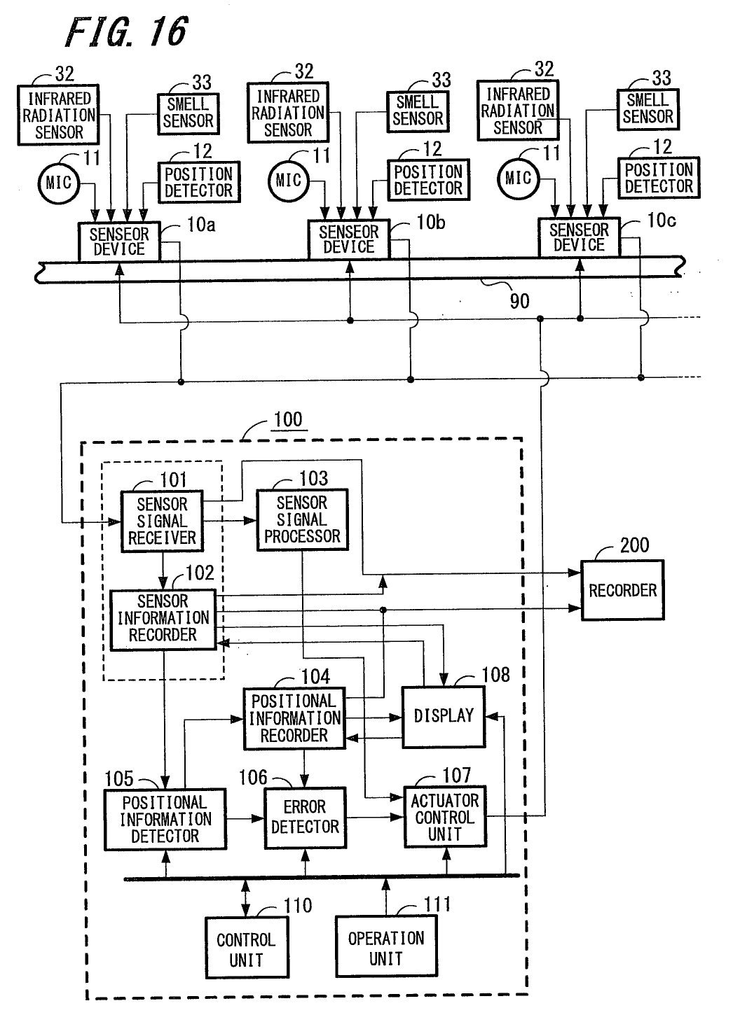

For example, as shown in FIG. 16, sensor devices 10a′, 10b′, 10c′, . . . can each include an infrared radiation sensor 32 detecting proximity of a subject or a smell sensor 33 other than the microphone 11.

In the sensor information obtaining apparatus 100, the positions where the infrared radiation sensor 32 or the smell sensor 33 detects the proximity of a subject or strong smell thereof are specified, and the sensor devices are closely arranged around the specified positions.

Other components of the system configuration example of FIG. 16 are configured the same as those illustrated in FIG. 1. Thus, the sensor device can more accurately detect sound source or the like by increasing the number of types of the sensor device.

In the example, each sensor device includes the microphone; however, each sensor device may include devices other than the microphone.

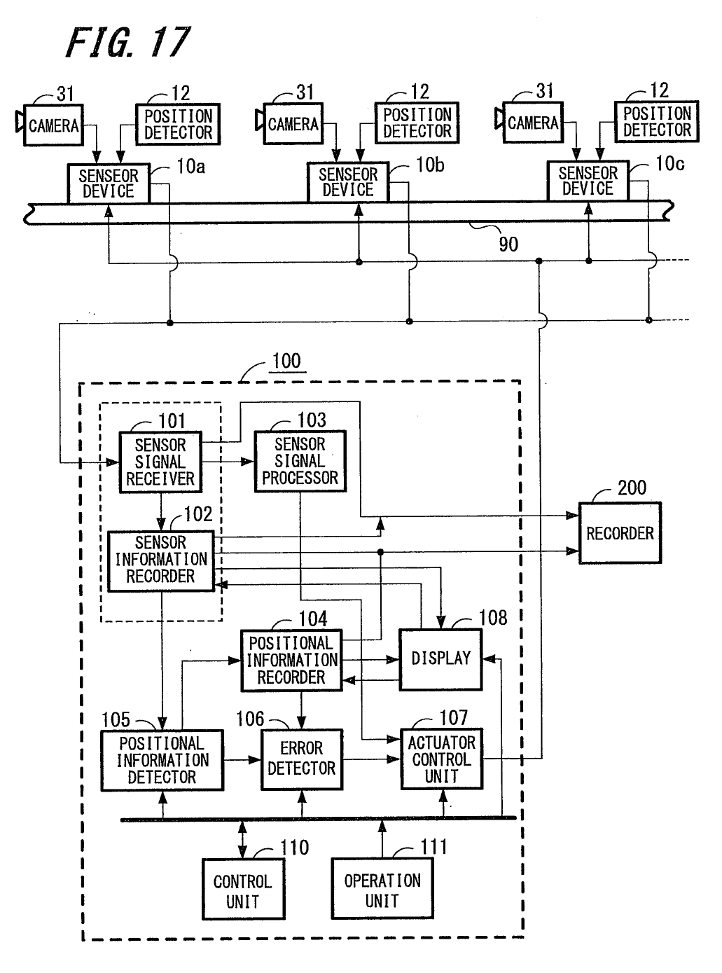

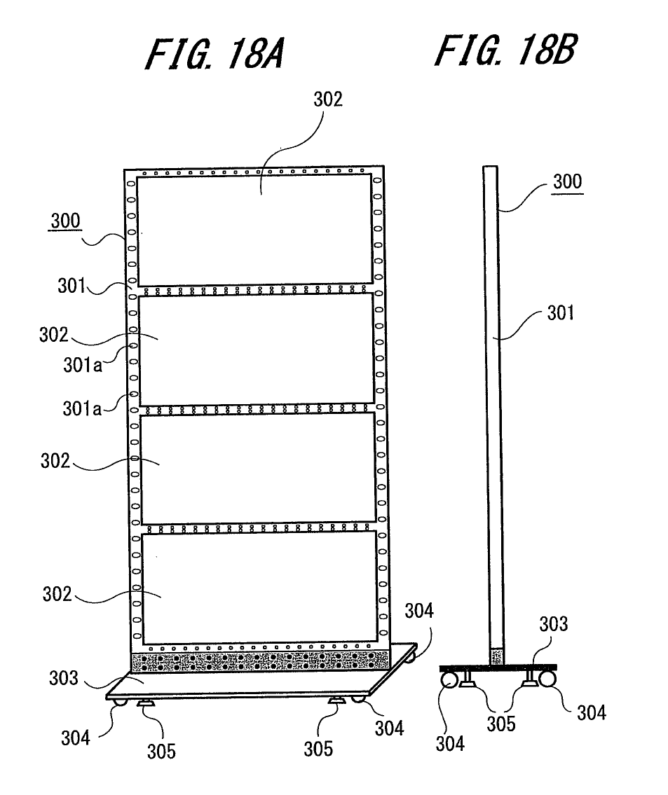

As illustrated in FIG. 17, for example, sensor devices 10a″, 10b″, 10c″, . . . , each includes a camera 31 to capture images. Image data obtained by the camera 31 can be transferred to the sensor information obtaining apparatus 100 and recorded by the recorder 200.

In this case, the density of object or subject images captured by the camera 31 is detected based on an amount of change in the images captured by the camera 31, and the sensor devices are closely arranged around the position where a large amount of change is detected whereas the sensor devices are sparsely arranged around the position where a small amount of change is detected. Alternatively, the sensor devices may each include sensors other than the camera 31 as shown in FIG. 16.

The amount of change in the images captured by the camera 31 may be obtained by comparing the images that are currently captured with the images that are captured immediately before. Alternatively, the change can be more accurately detected by the following process, in which the background image has previously been captured and stored, and the stored background image is then compared with currently captured images.

As shown in FIG. 17, suitable intervals for arranging the sensor devices can be obtained in the case of the cameras incorporated in the sensor devices that capture images of the subjects.

As described in the above embodiments, the positions of the sensor devices are detected by receiving and processing the positioning signals from GPS; however, the positions of the sensor devices can be detected by the following process, in which markers are provided at predetermined intervals on the rail, and positions of the sensor devices can simply be detected when the sensor devices pass through the markers. Alternatively, a motor can be incorporated in each sensor device such as stepper motor that can figure out an accurate travel distance corresponding to a driving signal, so that detecting position processing of the sensor devices can be omitted.

Mechanisms to drive the sensor devices may not also be limited to those described in FIGS. 3 to 6. For example, the sensor devices may not be configured to move along the rail, however, may each change the positions thereof two-dimensionally or three-dimensionally within a certain range of space.

In FIG. 1, the examples of the sensor information obtaining apparatus 100 and recorder 200 are configured as designated devices; however, programs (software) that carry out processing described in the flowcharts in FIG. 9 and FIG. 10 may be installed on a multi-purposed information processing apparatus to function as the sensor information obtaining apparatus 100.

In this case, the programs (software) installed on the information processing apparatus may be distributed with various medium such as disks or semiconductor memories.

Next, a display configuration and processing to display the data obtained from the aforementioned processing are described with reference to FIGS. 18 to 34.

First, an example of an overall configuration of an information presenting apparatus 300 is described with reference to FIGS. 18A, 18B. FIG. 18A is a front view of the information presenting apparatus 300, and FIG. 18B is a side view thereof.

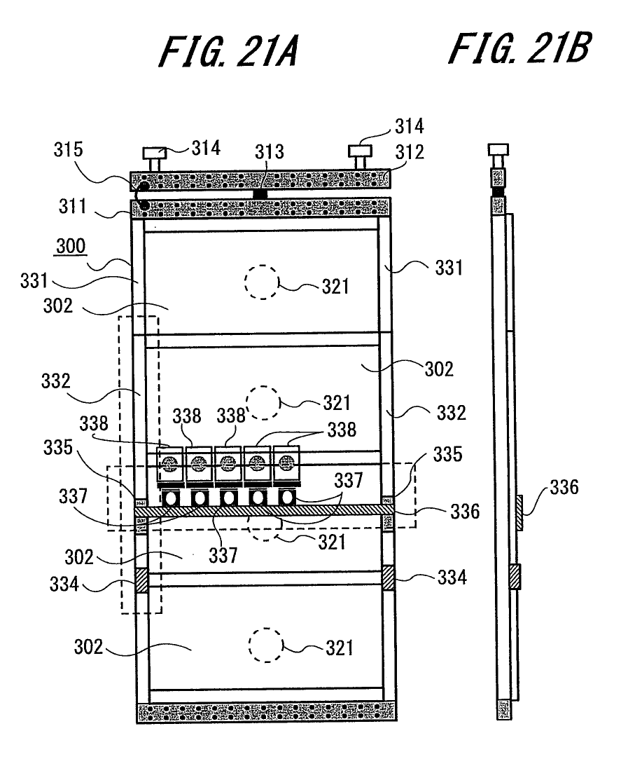

The information presenting apparatus 300 includes a plurality of flat speakers 302, and a frame 301 that holds the plurality of flat speakers 302 with each standing upright configuration that is stacked in a vertical direction. The example of the information presenting apparatus 300 in FIGS. 18A, 18B includes four speakers 300. The flat speakers 302 mainly output low audio frequency. The frame 301 includes a large number of holes (screw holes) 301a provided therein at predetermined intervals, through which side frames 331, 332 (see FIG. 21) are fixed with the screws.

The lower end of the frame 301 is fixed to abase 303, to the underside of which casters 304 and stoppers 305 are attached at four corners. The frame 301 can be moved with the casters 304 or be stabilized by the stoppers 305 at a setting position.

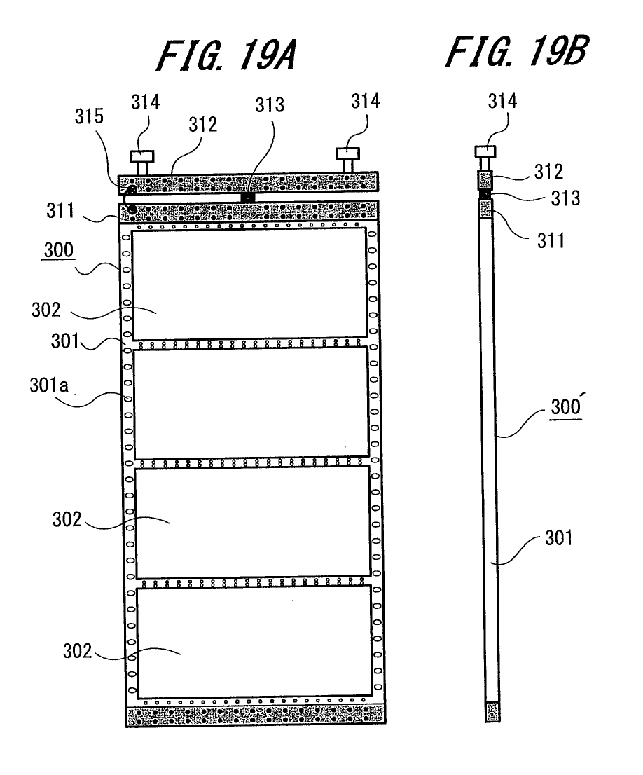

FIG. 19 illustrates another configuration example of the information presenting apparatus 300. FIG. 19A is a front view of the information presenting apparatus 300, and FIG. 19B is a side view thereof.

In the example in FIGS. 19A, 19B, the frame 301 is also configured to hold the plurality of speakers 302 as the example in FIGS. 18A, 18B; however, the frame is suspended from the upper side thereof. Specifically, as shown in FIGS. 19A, 19B, an upper holder 311 is provided on the upper end of the frame 301, to which a fixing unit 312 is connected via a rotary post 313. Mounting parts 314 are provided at a plurality of positions on the fixing unit 312, with which the information presenting apparatus 300 is attached to brackets provided on the walls or ceiling. The upper holder 311 and the fixing unit 312 are connected via signal lines 315, so that signals can be transmitted from the upper side of the information presenting apparatus 300 to the speakers.

With the configuration shown in FIGS. 19A, 19B, the information presenting apparatus 300 can be suspended from the ceiling or wall.

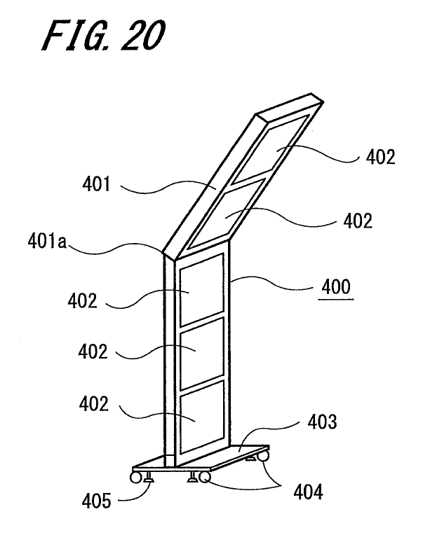

FIG. 20 illustrates an information presenting apparatus 400 having a different configuration. The information presenting apparatus 400 includes five flat speakers 402 vertically aligned, and a base 403 is provided at the lower end of the information presenting apparatus 400. Casters 404 and stoppers 405 are provided to the underside of the base 403. A frame 401 holding the flat speakers 402 includes a folding point 401a based on which the upper two flat speakers are inclined internally. The folding point 401a can be provided on a position differing from the point shown in FIG. 20.

Next, FIG. 21 illustrates a configuration example of the information presenting apparatus 300 according to the embodiment to which mobile information presenting devices are placed. In this example, side frames 331, 332 are respectively attached to the left and right sides of the frame 301 as shown in FIGS. 21A, 21B. Vertical direction drivers 335 are respectively attached to the left and right sides of the side frames 332 so that the vertical direction drivers 335 can move in vertical directions. The left and right side vertical direction drivers 335 are each connected via a rod type mobile carriage 336. The mobile carriage 336 is located at the front surface of the flat speakers 302.

A plurality of speakers 338 that are the mobile information presenting devices is arranged on the mobile carriage 338. The speakers 338 are movably attached such that the speakers are individually moved with a motor along the mobile carriage 336 in a horizontal direction. The speakers 338 are configured to output high audio frequency. The high audio frequency indicate sound in the frequency band higher than sound in the frequency band in which the flat speakers 302 output sound. Note that the frequency band in which the flat speakers 302 output sound can partially be overlapped with the frequency band in which the speakers 338 output sound.

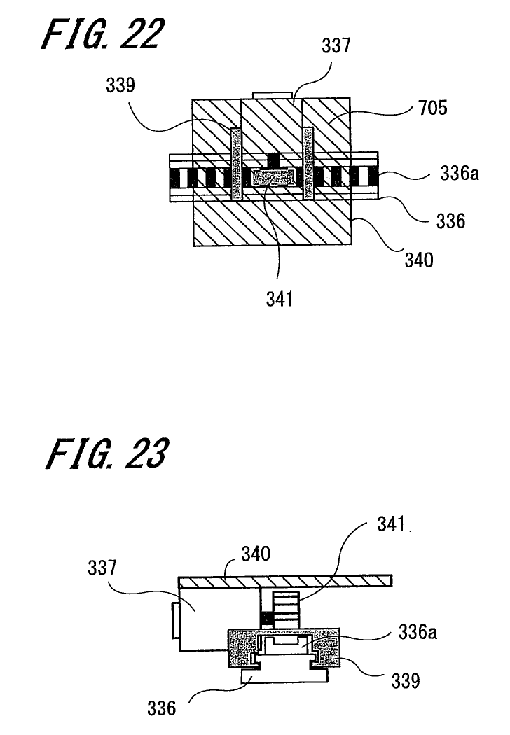

FIGS. 22 and 23 each illustrate an example of a mechanism to move the speaker 338 forming the mobile information presenting device.

FIG. 22 is a top view of the mechanism whereas FIG. 23 is a side view thereof.

The rod type mobile carriage 336 is provided with a rack mechanism 336a, with which a gear 341 attached to a rotating shaft of the motor 337 is engaged. A retainer 339 is slidably fitted to the mobile carriage 336 as shown in FIG. 23, and a platform 340 is attached on top of the motor 337. The speaker 338 in FIG. 21 is placed on the platform 340.

Accordingly, each of the mobile information presenting devices can move per se along the rod type mobile carriage 336 by causing the motor to drive to rotate the gear 341, and the speakers 338 forming the mobile information presenting devices can thus be placed in arbitrary positions in a horizontal direction (traverse direction in FIG. 21). Although not shown, a position sensor is arranged on the motor 337 to detect the position of the mobile carriage 336.

Likewise, the left and right vertical direction drivers 335 shown in FIG. 21 can each be moved in a vertical direction by driving an actuator such as a motor.

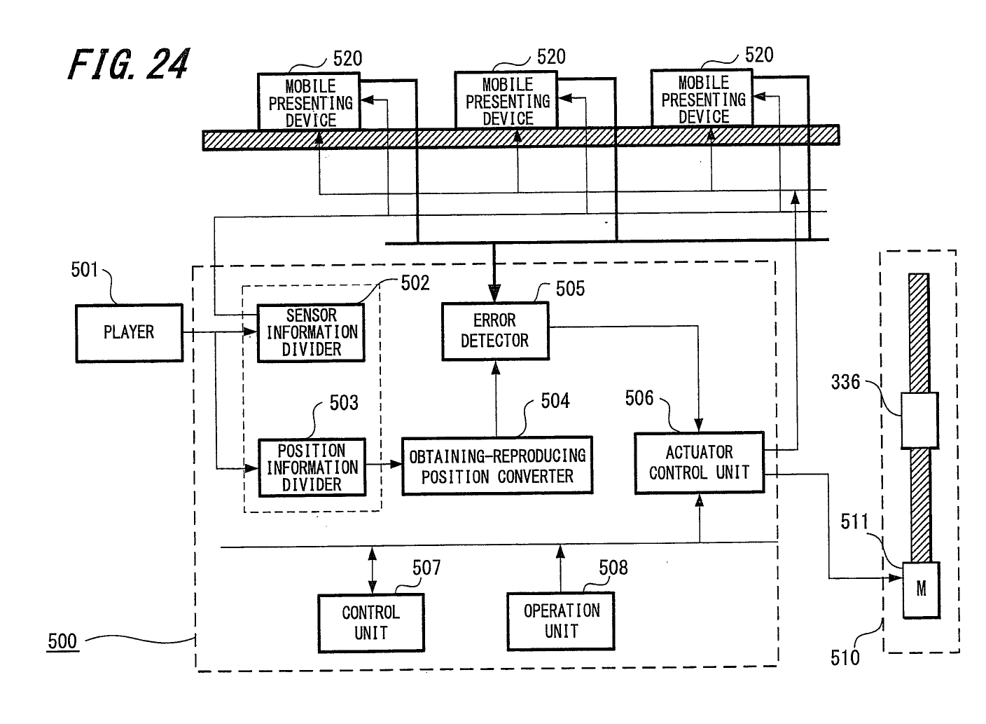

FIG. 24 is a configuration example of an overall system utilizing the information presenting apparatus 300.

An information reproducing apparatus 500, to which a player 501 is connected, controls the information presenting apparatus 300. The player 501 includes the data that has been recorded by the recorder 200 (see FIG. 1) in the processing configurations in FIG. 1 to FIG. 17, and reproduces the recorded data. Specifically, on the player 501, data obtained by a plurality of sensors, such as a plurality of microphones 11, and information on the positions of the sensors obtained when the sensors have obtained data are recorded.

The data reproduced by the player 501 is supplied to a sensor information divider 502 and a positional information divider 503, respectively, so that the data is divided into the two in the information reproducing apparatus 500. The sensor information divided by the sensor information divider 502 is audio data. The positional information divided by the positional information divider 503 indicates information on the positions of the sensors (microphones in this case).

The sensor information divided by the sensor information divider 502 is individually supplied to mobile information presenting devices 520. The mobile information presenting devices 520 correspond to the speakers 338 in FIG. 21.

The positional information divided by the positional information divider 503 is supplied to an obtaining-reproducing position converter 504 to convert collected positional information into reproducing positional information for each mobile information presenting device 520. This conversion involves the conversion of data format between the obtained data and the data operable by an actuator such as a motor. The conversion may also involve converting processing to adjust the difference between the two ranges in a case where the variable range of the sensor positions recorded by the recorder 200 differs from the variable range in which the mobile information presenting devices 520 can be moved on the information presenting apparatus 300.

The positional information output by the obtaining-reproducing position converter 504 is supplied to an error detector 505 to detect the difference in the distance between output positional information and an actual position of each of the mobile information presenting devices 520. The detected information on the difference in the distance is supplied to an actuator control unit 506 so that an actuator (i.e., motor 337 in FIG. 21) in each of the mobile information presenting devices 520 can move according to the distance obtained by the difference. The information output from the actuator control unit 506 is supplied to an electrical actuator 510 to drive a motor (not shown) of the vertical direction drivers 335 shown in FIG. 21 in a vertical direction. The electrical actuator 510 is used for moving the mobile carriage in a vertical direction.

Processing in the information reproducing apparatus 500 is controlled by a control unit 507. The information reproducing apparatus 500 further includes an operation unit 508, based on an operational status of which the control unit 507 controls components of the information reproducing apparatus 500. The description so far illustrates processing in which a position of each of the mobile information presenting devices 520 is controlled according to data reproduced by the player 501; however, a position of each of the mobile information presenting devices can be specified by the operation unit 508. Alternatively, a position of each of the mobile information presenting devices specified by the player 501 may be adjusted by the operation unit 508.

Of the audio data reproduced by the player 501, low-frequency audio data is supplied to the flat speakers 302 of the information presenting apparatus 300, and only low-frequency audio data can be supplied from the player 501 to the information reproducing apparatus 500. Alternatively, the audio data in an entire frequency range is supplied from the player 501 to the information reproducing apparatus 500 so as to output the audio data from the speakers incorporated in the respective mobile information presenting devices. In this case, the flat speakers 302 on the information presenting apparatus 300 may not be used.

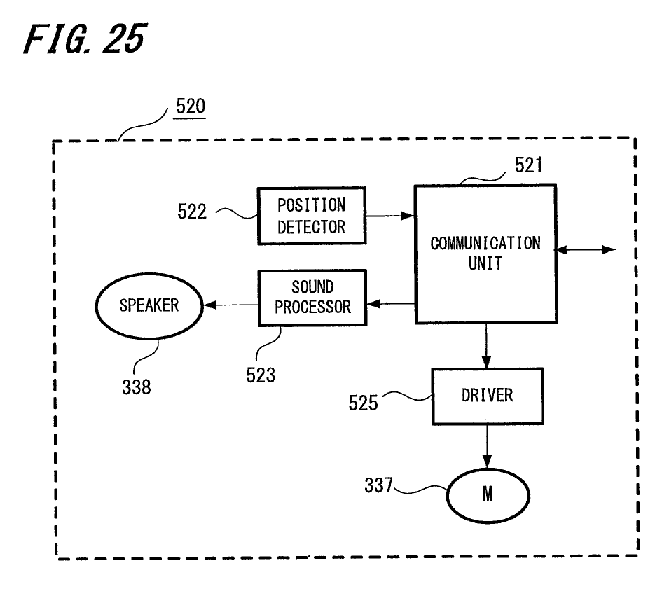

FIG. 25 is a diagram illustrating an internal configuration example of the mobile information presenting device. The mobile information presenting device 520 includes a communication unit 521 to communicate with the information reproducing apparatus 500. In the data received by the communication unit 521, the audio data is supplied to the speaker 338 to output therefrom via a sound processor 523. Data to drive the motor 337 is supplied to a driver 525 to rotate the motor 337.

The mobile information presenting device 520 includes a position detector 522 to detect the position thereof, and positional information on the mobile information presenting device 521 detected by the position detector 522 is transferred from the communication unit 521 to the information reproducing apparatus 500.

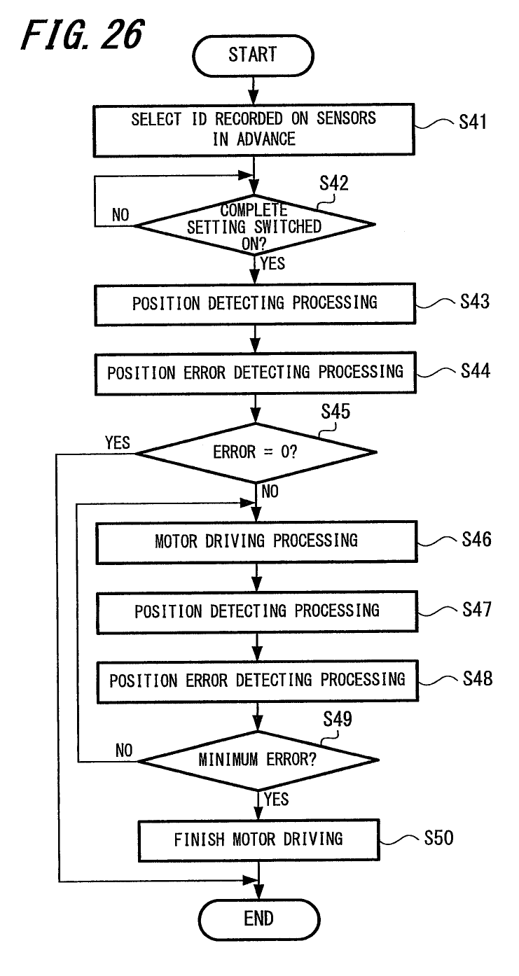

Next, an example of control processing carried out by the information reproducing apparatus 500 is described with reference to a flowchart in FIG. 26. First, an identification number (ID) of a sensor device (mobile information presenting device 520) to be moved is selected (step S41) in the information reproducing apparatus 500. ID is individually provided for each of the sensor devices prepared in advance. When the ID is selected, the information reproducing apparatus 500 turns in a standby state until whether the mobile information presenting device in question has been switched on is determined with reference to a response from the mobile information presenting device in question (step S42). On determining the mobile information presenting device 520 in question that has been switched on, the absolute current position of the mobile information presenting device 520 in question is detected by the position detector 522 incorporated therein (step S43).

Error detection processing is then carried out by determining whether there is a difference between a target position of the mobile information presenting device 520 specified by the information reproducing apparatus 500 and the current position of the mobile information presenting device 520 (step S44). In the error detection processing, whether the error has been zero is determined (step S45). If the error is determined as zero, the moving control processing carried out on the mobile information presenting device 520 having the selected ID will end.

If the error is not determined as zero, motor driving instructions are transferred to the mobile information presenting device 520 so that the mobile information presenting device 520 is moved with a distance corresponding to the error (step S46). The current position of the moved mobile information presenting device 520 is then measured by the position detector 522 incorporated in the mobile information presenting device 520 (step S47), and the error detection processing is conducted by determining whether there is a difference between the target position of the mobile information presenting device 520 specified by the information reproducing apparatus 500 and the current position of the mobile information presenting device 520 (step S48).

Subsequently, whether the error obtained has been the smallest is determined (step S49), and if the error is not the smallest, the processing of step S46 is repeated to adjust the position of the mobile information presenting device 520 again. If the error obtained is the smallest at step S49, driving control of the motor will end (step S50), and moving control processing of the mobile information presenting device 520 with the selected ID will subsequently end.

Thus, the mobile information presenting devices 520 can individually be moved utilizing the sensor information obtained from the processing described in FIG. 1 to FIG. 17. Further, intervals between the sensors can be changed by outputting data such as the audio sound collected by the sensors to the mobile information presenting device 520, so that the sensors are suitably arranged according to data obtained field conditions. Simultaneously, the sensors may repeatedly be located at the same positions. Thus, the field conditions in which the audio sound has been recorded can excellently be reproduced.

The configuration of the information presenting apparatus 300 illustrated is only one example, and thus the information presenting apparatus 300 may include other configurations.

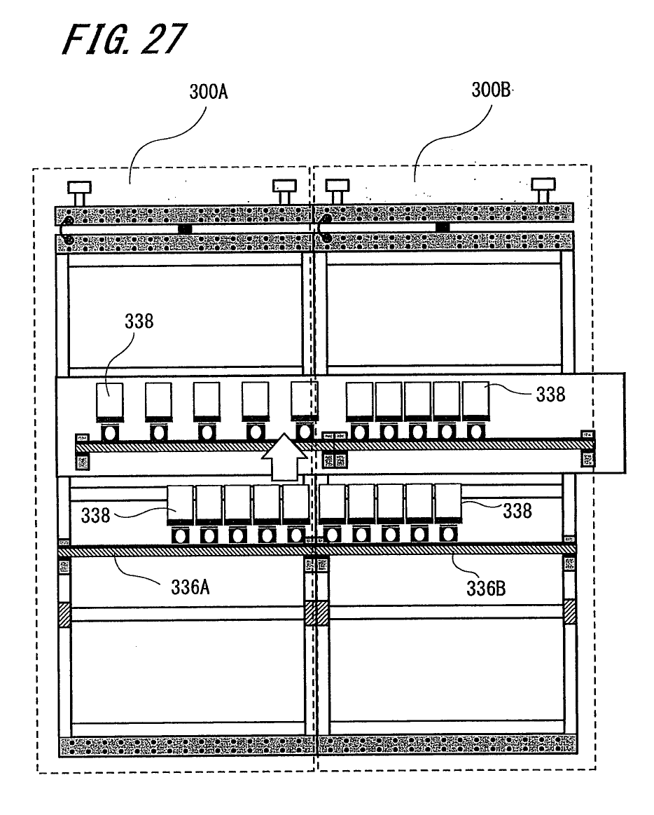

For example, two information presenting apparatuses 300A, 300B may be connected in a crosswise direction as shown in FIG. 27. The speakers 338 on mobile carriages 336A, 336B respectively attached to the information presenting apparatuses 300A, 300B may be individually controlled and each located at an arbitrary position. The numbers of the speakers 338 may be increased in this manner.

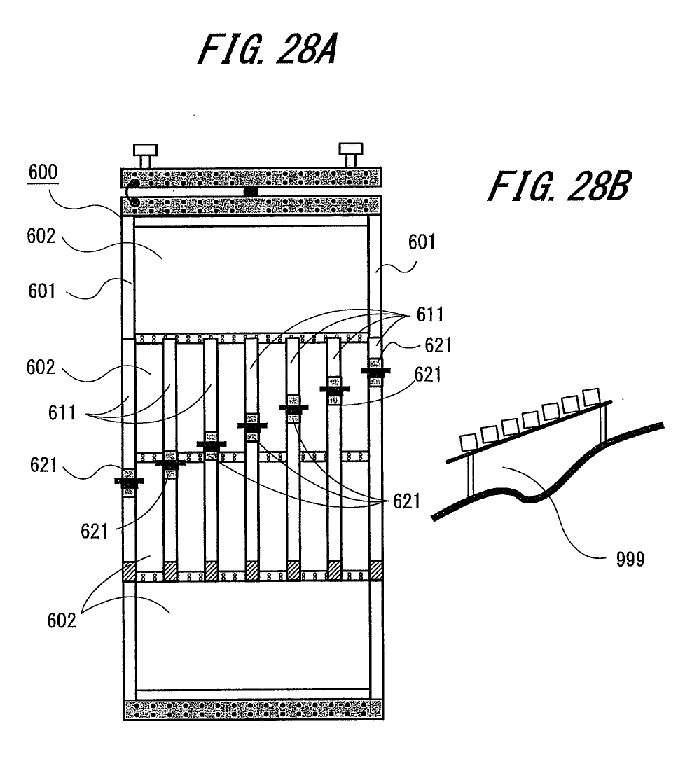

As shown in FIG. 28A, an information presenting apparatus 600 may be configured to include a plurality of vertical frames 611 arranged in a vertical direction. Specifically, the information presenting apparatus 600 may be configured similar to the information presenting apparatus 300 in a manner such that the information presenting apparatus 600 includes flat speakers 602 supported by frames 601. The plurality of vertical frames 611 are arranged in parallel at the front of the flat speakers 602 in a vertical direction. Then, mobile presenting devices 621 are provided on the vertical frames 611 to be moved in a direction vertical thereto, and speakers or the like are arranged on the mobile presenting devices 621.

With the information presenting apparatus having the configuration illustrated in FIG. 28A, an array of sensors 999 obliquely aligned as shown in FIG. 28B can repeatedly be located at the same positions.

Alternatively, an information presenting apparatus 700 includes a plurality of movable mobile carriages 711, 721, 731, 741, on respective of which a plurality of mobile presenting devices 712, 722, 732, 742 each capable of moving in a horizontal direction are provided. In this case, mobile carriages 711 and 731 are supported by frames 701 while mobile carriages 721 and 741 are supported by sub-frames 702. Thus, ranges a, b, c, d of in which the mobile carriages 711, 721, 731, 741 can each be moved in a vertical direction can mutually be overlapped.

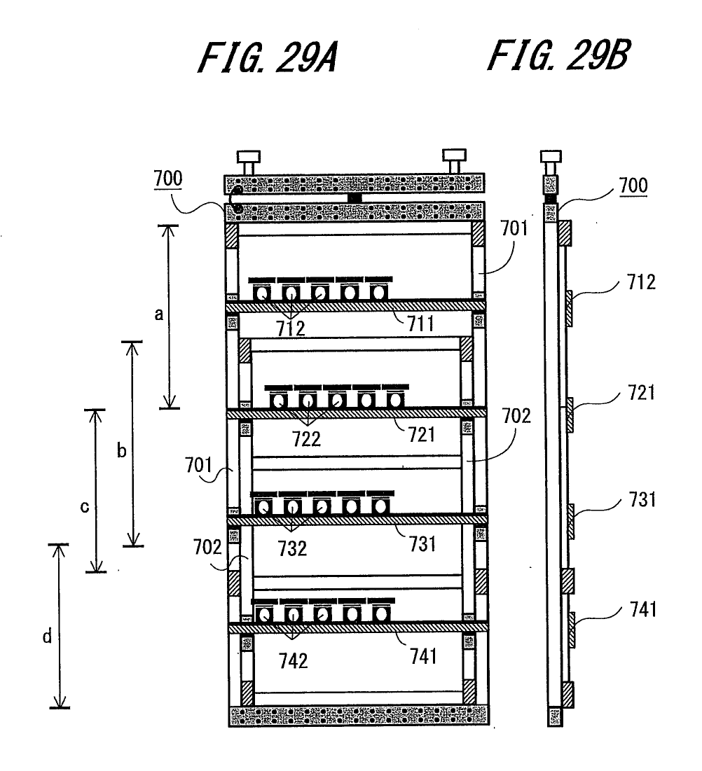

Since the information presenting apparatus 700 shown in FIG. 29 includes mobile presenting devices 712, 722, 732, 742 arranged on the plurality of stages, an excellent sound output condition can be obtained.

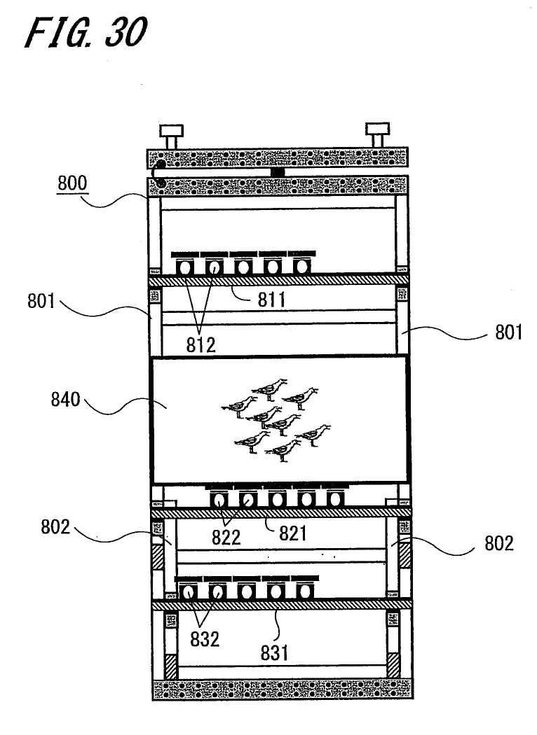

Alternatively, an information presenting apparatus 800 may include a display 840 arranged thereon as shown in FIG. 30. Specifically, the information presenting apparatus 800 includes a plurality of mobile carriages 811, 821, 831 supported by frames 801 or sub-frames 802, on respective of which a plurality of mobile presenting devices 812, 822, 832 are arranged. Speakers are arranged on the respective mobile presenting devices 812, 822, 832. The display 840 is arranged on an arbitrary position of the information presenting apparatus 800. Alternatively, the display 840 may also be mounted on the mobile presenting devices to be moved on the information presenting apparatus 800.

The example of the information presenting apparatus 800 in FIG. 30 only includes one display 840; however, the information presenting apparatus 800 may include a plurality of displays arranged thereon, and positions of the displays can be controlled based on the positional information on video data attached thereto. In a case of controlling the positions of the displays 840 based on the positional information, a plurality of video cameras 31 are employed as sensors as shown in FIG. 17.

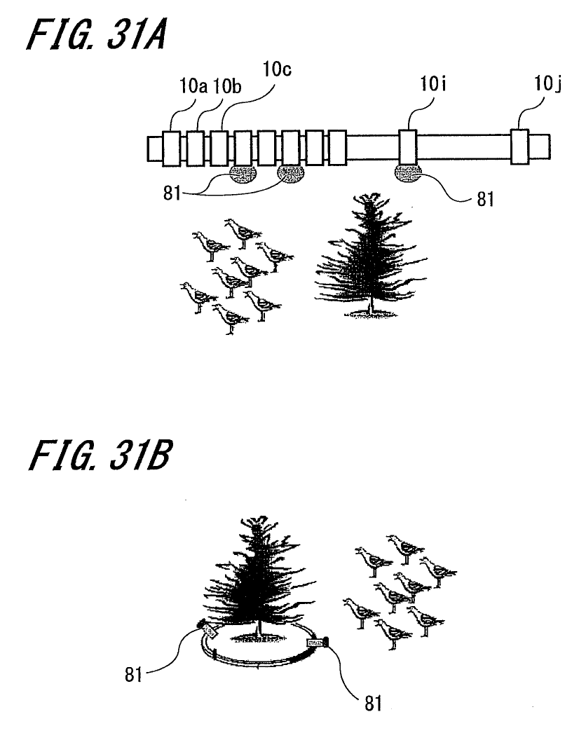

Or the information presenting apparatus 800 may optionally include the arbitrary number of various sensors 81 differing from microphones in recording as shown in FIGS. 31A, 31B, such that various information output by the sensors can be displayed instead of audio sound or video images.

As shown in FIG. 27, more than two information presenting apparatuses may be prepared and arranged. For example, a plurality of information presenting apparatuses can be arranged in a circular manner.

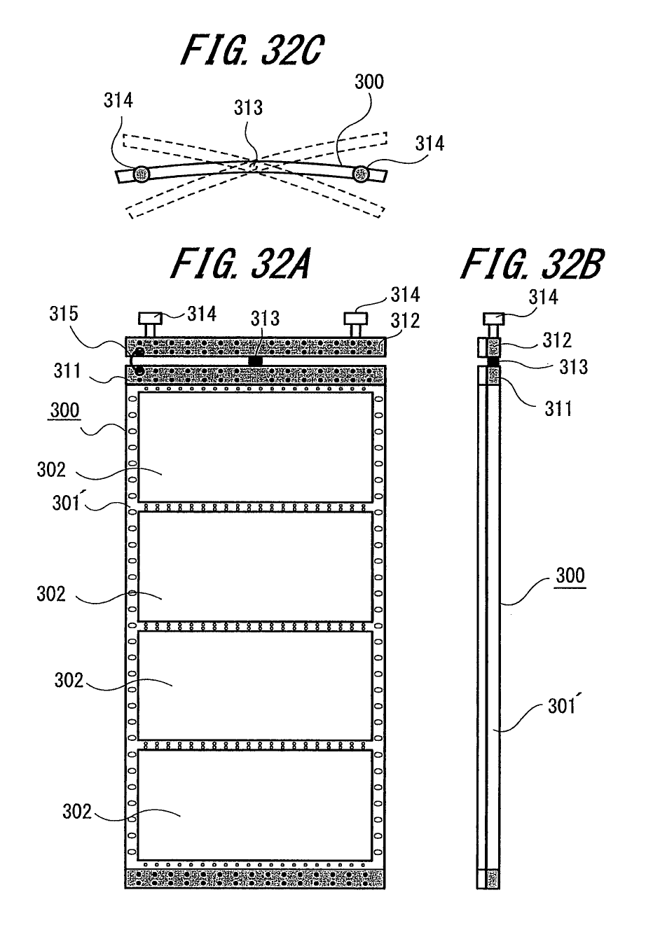

In this case, for example, the frames 301′ of the information presenting apparatuses 300 are each formed in a curved manner as shown in FIG. 32. FIG. 32C is a top view illustrating the frame 301′ that is formed in a curved manner.

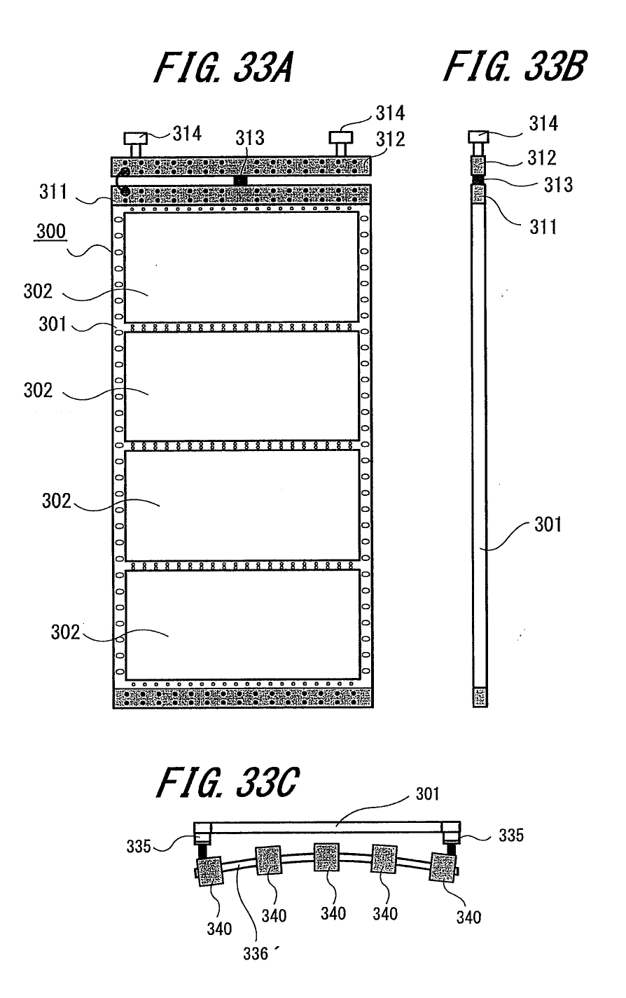

Alternatively, as shown in FIG. 33, flat type frames 301 may be used as the information presenting apparatuses 300 as those shown in FIG. 18, however, rod type mobile carriages 336′ may also be formed as the information presenting apparatuses 300 in a curved manner. FIG. 33C is a top view illustrating the mobile carriage 336′ that is formed in a curved manner.

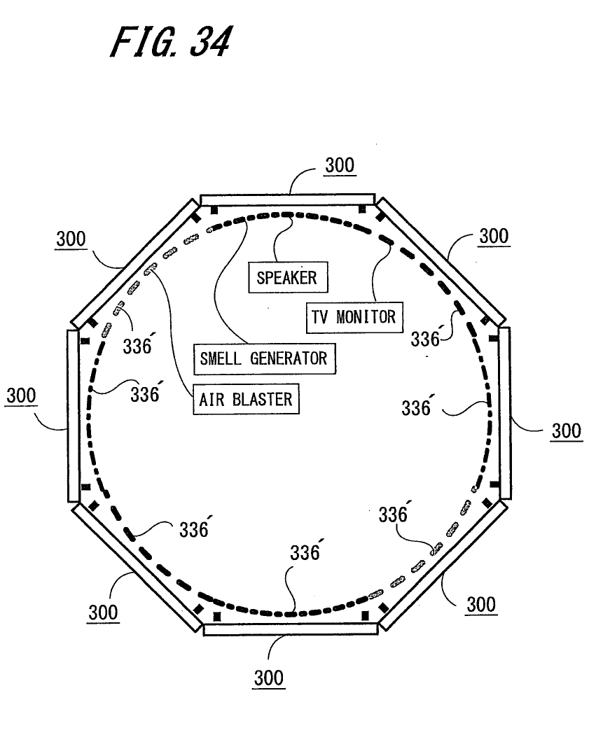

FIG. 34 shows an example in which the plurality of information presenting apparatuses 300 each having the curved mobile carriage 336′ are connected and arranged in a circular manner.

As shown in FIG. 34, since the plurality of information presenting apparatuses 300 respectively include speakers, displays, smell generators, air blasters, and the like as mobile presenting devices movably mounted on the mobile carriages 336′ and respectively control positions of such movable mobile presenting devices, an environment in which recording images, sound, smelling, and the like have been recorded can be reproduced.

It should be understood by those skilled in the art that various modifications, combinations, sub-combinations and alterations may occur depending on design requirements and other factors insofar as they are within the scope of the appended claims or the equivalents thereof.

What is claimed is:

1. A sensor information obtaining apparatus comprising:
a plurality of sensors each configured to obtain positional information thereof; and
a sensor position control unit configured to control positions of the sensors to be moved based on distribution of data obtained by the sensors and distribution of positions of the sensors.

2. A sensor information obtaining apparatus according to claim 1, wherein
the distribution of data is obtained by the plurality of sensors moved to predetermined initial positions.

3. A sensor information obtaining apparatus according to claim 2, wherein
the sensors are microphones and the distribution of data is distribution of sound pressure levels of audio data obtained by the microphones.

4. A sensor information obtaining apparatus according to claim 2, wherein
the sensors are cameras and the distribution of data is distribution of an image data variation obtained by the cameras.

5. A sensor information obtaining apparatus according to claim 2, further comprising:
a storage configured to store positional information on each of the sensors, wherein
the sensor position control unit controls a position of each of the sensors based on the positional information on each of the sensors stored in the storage.

6. A sensor device for use in a sensor information obtaining system, the sensor comprising:
a sensor function unit configured to obtain predetermined data; and
a position information obtaining unit configured to obtain positional information on the sensor device.

7. A sensor device according to claim 6, further comprising:
an output unit configured to add the positional information obtained by the position information obtaining unit to the predetermined data obtained by the sensor function unit and to output the resulting data.

8. A sensor device according to claim 7, further comprising:
a driver configured to move a position of the sensor device.

9. A sensor device according to claim 8, further comprising:
a control unit configured to determine a position to which the sensor device is moved by the driver, and to cause the driver to move the sensor device to the determined position.

10. An information presenting apparatus comprising:
a plurality of information presenting units configured to present information obtained by a plurality of sensors;
driving mechanisms configured to variably-set positions of the information presenting units; and
a control unit configured to control the driving mechanisms according to positional information obtained when the sensors have obtained the information to individually set positions of the information presenting units.

11. An information presenting apparatus according to claim 10, wherein
the sensors are microphones, the information presenting units are speakers that output audio sound collected by the microphones, and the positional information indicates positions in which the microphones are arranged when collecting audio sound.

12. An information presenting apparatus according to claim 11, further comprising:
speakers that are separate from the speakers used as the information presenting units, wherein the separate speakers output low audio frequency, and the speakers used as the information presenting units output high audio frequency.

13. An information presenting apparatus according to claim 10, wherein
the sensors are video cameras, and the information presenting units are displays that output images obtained by the video cameras.

14. A mobile information presenting device comprising:
an information presenting unit configured to output predetermined data; and
a driving mechanism configured to move the information presenting unit based on positional information added to the predetermined data presented by the information presenting unit.

15. A mobile information presenting device according to claim 14, wherein
the information presenting unit is a speaker configured to output audio sound information, and the positional information is information on a position obtained when the audio sound information has been collected.

16. A mobile information presenting device according to claim 14, wherein
the information presenting unit indicates a display configured to output image information, and the positional information includes information on a position obtained when the image information has been recorded by the camera.

17. A method of controlling sensors comprising:
obtaining positional information on movable sensors; and
moving positions of the sensors based on distribution of data obtained by the sensors and distribution of positions of the sensors.

18. A method of controlling sensors comprising:
obtaining positional information on each of the sensors while obtaining predetermined data using a sensor function unit; and
outputting the obtained positional information and the predetermined data.

19. A method of presenting information comprising:
individually presenting pieces of information obtained by a plurality of sensors; and
individually setting positions obtained when the pieces of information are presented corresponding to positional information obtained when the sensors have individually obtained the pieces of information.

20. A method of presenting information comprising:
presenting information by outputting predetermined data; and
moving a position at which the information is presented based on positional information added to the predetermined data.
